(19) United States
(12) Patent Application Publication
(10) Pub. No.: US 2026/0149376 A1
(43) Pub. Date: May 28, 2026

(54) CURRENT BALANCE CIRCUIT AND MULTI-PHASE BUCK-CONVERTER INCLUDING THE SAME AND CURRENT BALANCING METHOD THEREOF

(71) Applicant: Samsung Electronics Co., Ltd., Suwon-si (KR)

(72) Inventors: Hongseok SHIN, Suwon-si (KR); Dongyeon KWAG, Suwon-si (KR); Hyeungjoon CHA, Suwon-si (KR); Dae-Hoon HAN, Suwon-si (KR)

(73) Assignee: Samsung Electronics Co., Ltd., Suwon-si (KR)

(21) Appl. No.: 19/251,161

(22) Filed: Jun. 26, 2025

(30) Foreign Application Priority Data
Nov. 25, 2024 (KR) 10-2024-0170157
Jan. 10, 2025 (KR) 10-2025-0004147

(51) Int. Cl. H02M 3/158; H02M 1/00; H02M 1/14

(52) U.S. Cl. CPC H02M 3/158; H02M 1/0009; H02M 1/14

(57) ABSTRACT

A dual-phase buck-converter including a DC resistance detection circuit that detects first and second DC resistances of respective first and second inductors that transmit master and slave currents to a load, and generates first and second reference voltages indicative of the first and second DC resistances; a current sensor that detects a master average current flowing through the first inductor, and a slave average current flowing through the second inductor; a current balance circuit that generates a master on-time control voltage and a slave on-time control voltage for controlling matching of the master and slave average currents, based on the first and second reference voltages; an on-time controller that generates a master duty signal and a slave duty signal based on the master on-time control voltage and the slave on-time control voltage; and a buck-converter that supplies the master and slave currents based on the master and slave duty signals.

### CROSS-REFERENCE TO RELATED APPLICATIONS

This application claims priority under 35 U.S.C. § 119 to Korean Patent Application No. 10-2024-0170157 filed on Nov. 25, 2024, and Korean Patent Application No. 10-2025-0004147 filed on Jan. 10, 2025, in the Korean Intellectual Property Office, the disclosures of which are incorporated by reference herein in their entireties.

### BACKGROUND

Some example embodiments of the present disclosure described herein relate to semiconductor devices, and more specifically, to dual-phase buck-converters including a current balance circuit and a current balancing method thereof.

A DC-DC converter is a device that converts input DC power into various power forms and supplies them to specific devices or circuits. In general, DC-DC converters may be classified into a step-down type buck-converter, a step-up type boost converter, and a step-up/down type buck-boost converter. These may include switching mode converters that generate output voltage by controlling the switching on-off time (or duty) of the power switch.

A buck-converter, a type of step-down converter, receives a high voltage as input and converts it to a voltage lower than the power level. The buck-converter uses the converted voltage to supply the power required for the load.

### SUMMARY

Some example embodiments of the present disclosure provide a multi-phase buck-converter including a current balance circuit capable of limiting and/or preventing a current imbalance between a master path and a slave path caused by a difference in DC resistance DCR between inductors, and a current balancing method thereof.

Some example embodiments of the present disclosure provide a dual-phase buck-converter that includes a first inductor that transmits a master inductor current having a first phase to a load; a second inductor that transmits a slave inductor current having a second phase to the load; a DC resistance detection circuit that detects a DC resistance of the first inductor and generates a first reference voltage indicative of the DC resistance of the first inductor, and that detects a DC resistance of the second inductor and generates a second reference voltage indicative of the DC resistance of the second inductor; a current sensor that detects a master average current corresponding to an average value of the master inductor current, and detects a slave average current corresponding to an average value of the slave inductor current; a current balance circuit that generates a master on-time control voltage and a slave on-time control voltage for controlling matching of the master average current and the slave average current, based on the first reference voltage and the second reference voltage; an on-time controller that generates a master duty signal and a slave duty signal based on the master on-time control voltage and the slave on-time control voltage; and a buck-converter that supplies the master inductor current for the first inductor based on the master duty signal, and supplies the slave inductor current for the second inductor based on the slave duty signal.

Some example embodiments of the present disclosure provide a dual-phase buck-converter that includes a first buck-converter that generates a master inductor current having a first phase; a first inductor that transmits the master inductor current from the first buck-converter to a load; a second buck-converter that generates a slave inductor current having a second phase; a second inductor that transmits the slave inductor current from the second buck-converter to the load; a first DC resistance detector that detects a first DC resistance of the first inductor and generates a first reference voltage indicative of the first DC resistance; a second DC resistance detector that detects a second DC resistance of the second inductor and generates a second reference voltage indicative of the second DC resistance; and a current balance circuit that generates a master on-time control voltage and a slave on-time control voltage for controlling balancing of the master inductor current and the slave inductor current, based on the first reference voltage and the second reference voltage. The first buck-converter generates the master inductor current based on the master on-time control voltage, and the second buck-converter generates the slave inductor current based on the slave on-time control voltage.

Some example embodiments of the present disclosure provide a dual-phase buck-converter that includes a master buck-converter chip that provides a master inductor current to a load through a first inductor; a slave buck-converter chip that provides a slave inductor current to the load through a second inductor; a first DC resistance detection circuit that detects a first DC resistance value of the first inductor and generates a first reference voltage indicative of the first DC resistance value; and a second DC resistance detection circuit that detects a second DC resistance value of the second inductor and generates a second reference voltage indicative of the second DC resistance value. The master buck-converter chip further generates a master average current corresponding to an average value of the master inductor current flowing in the first inductor; generates a master on-time control voltage reflecting the first DC resistance value based on the master average current, the first reference voltage and the second reference voltage; generates a master duty signal based on the master on-time control voltage, and controls the master average current based on the master duty signal. The slave buck-converter chip further generates a slave average current corresponding to an average value of the slave inductor current flowing in the second inductor; generates a slave on-time control voltage reflecting the second DC resistance value based on the slave average current, the first reference voltage and the second reference voltage; generates a slave duty signal based on the slave on-time control voltage; and controls the slave average current based on the slave duty signal.

Some example embodiments of the present disclosure provide a current balancing method of a dual-phase buck-converter that supplies inductor currents of different phases to a load, the method including supplying a master inductor current to the load through a master inductor; supplying a slave inductor current to the load through a slave inductor; generating a first reference voltage indicative of a first DC resistance value of the master inductor; generating a second reference voltage indicative of a second DC resistance value of the slave inductor; detecting a master average current that is an average value of the master inductor current flowing in the master inductor; detecting a slave average current that is an average value of the slave inductor current flowing in the slave inductor; generating a master on-time control voltage reflecting the first DC resistance value and a slave on-time control voltage reflecting the second DC resistance value using the master average current, the slave average current, the first reference voltage, and the second reference voltage; and generating a master duty signal and a slave duty signal for controlling matching of the master average current and the slave average current based on the master on-time control voltage and the slave on-time control voltage.

In some example embodiments of the current balancing method, the generating the first reference voltage includes using a first filter circuit connected in parallel to both ends of the master inductor to generate the first reference voltage, and the generating the second reference voltage includes using a second filter circuit connected in parallel to both ends of the slave inductor to generate the second reference voltage.

In some example embodiments of the current balancing method, the first filter circuit and the second filter circuit include resistor-capacitor filters.

In some example embodiments of the current balancing method, the generating the master on-time control voltage is based on the first reference voltage, and a first voltage corresponding to a difference between half of the master average current and a reference current value.

In some example embodiments of the current balancing method, the generating the slave on-time control voltage is based on the second reference voltage, and a second voltage corresponding to a difference between half of the slave average current and the reference current.

In some example embodiments of the current balancing method, the reference current corresponds to an average value of the master average current and the slave average current.

Some example embodiments of the inventive concepts provide a mobile electronic device that includes a dual-phase buck-converter that transforms a power supply voltage into an output voltage; and a power management integrated circuit that converts the output voltage from the dual-phase buck-converter into respective component voltages for use by components of the mobile electronic device. The dual-phase buck-converter includes a first buck-converter that generates a master inductor current having a first phase; a first inductor that transmits the master inductor current from the first buck-converter to an output terminal of the dual-phase buck-converter; a second buck-converter that generates a slave inductor current having a second phase; a second inductor that transmits the slave inductor current from the second buck-converter to the output terminal; a first DC resistance detector that detects a first DC resistance of the first inductor and generates a first reference voltage indicative of the first DC resistance; a second DC resistance detector that detects a second DC resistance of the second inductor and generates a second reference voltage indicative of the second DC resistance; and a current balance circuit that generates a master on-time control voltage and a slave on-time control voltage for controlling balancing of the master inductor current and the slave inductor current, based on the first reference voltage and the second reference voltage. The first buck-converter generates the master inductor current based on the master on-time control voltage, and the second buck-converter generates the slave inductor current based on the slave on-time control signal.

In some example embodiments of the mobile electronic device, the dual-phase buck-converter and the power management integrated circuit are respective first and second integrated circuit chips.

In some example embodiments of the mobile electronic device, the dual-phase buck-converter further includes a current sensor that detects a master average current corresponding to an average value of the master inductor current flowing in the first inductor, and detects a slave average current corresponding to an average value of the slave inductor current flowing in the second inductor.

In some example embodiments of the mobile electronic device, the current balance circuit includes a first trans-conductor that generates a first voltage corresponding to a difference between half of the master average current and a reference current value; a first buffer that buffers the first reference voltage; and a first feedback resistor that adds the first reference voltage buffered by the first buffer to the first voltage to provide the master on-time control voltage.

In some example embodiments of the mobile electronic device, the current balance circuit further includes a second trans-conductor that generates a second voltage corresponding to a difference between half of the slave average current and the reference current value; a second buffer that buffers the second reference voltage; and a second feedback resistor that adds the second reference voltage buffered by the second buffer to the second voltage to provide the slave on-time control voltage.

In some example embodiments of the mobile electronic device, the reference current value corresponds to an average value of the master average current and the slave average current.

In some example embodiments of the mobile electronic device, the dual-phase buck-converter further includes an on-time controller that generates a master duty signal and a slave duty signal based on the master on-time control voltage and the slave on-time control voltage. The first buck-converter generates the master inductor current responsive to the master duty signal, and the second buck-converter generates the slave inductor current responsive to the slave duty signal.

### BRIEF DESCRIPTION OF THE DRAWINGS

The above and other objects and features of the present disclosure will become apparent in view of the following detailed description of some example embodiments as made with reference to the accompanying drawings.

FIG. 1 is a block diagram of a dual-phase buck-converter according to some example embodiments of the inventive concepts.

FIG. 2 is a diagram briefly showing an configuration of the buck-converter of FIG. 1 according to some example embodiments.

FIG. 3 is a circuit diagram showing a structure of a DC resistance detection unit of the inventive concepts shown in FIG. 1 according to some example embodiments.

FIG. 4 is a diagram showing a current sensor and a current balance circuit of FIG. 1 according to some example embodiments.

FIG. 5 is a diagram showing an on-time controller shown in FIG. 1 according to some example embodiments.

FIG. 6 is a waveform diagram showing the operation of the master on-time controller of FIG. 5.

FIG. 7 is a waveform diagram showing the operation of the slave on-time controller of FIG. 5.

FIG. 8 is a waveform diagram showing the current balancing effect of the dual-phase buck-converter according to some example embodiments.

FIG. 9 is a waveform diagram showing a section between time points T3 and T4 of FIG. 8.

FIG. 10 is a flowchart showing a current balancing method of a dual-phase buck-converter according to some example embodiments.

FIG. 11 is a diagram showing a dual-phase buck-converter according to some example embodiments of the inventive concepts.

FIG. 12 is a block diagram showing a mobile device including a dual-phase buck-converter according to some example embodiments of the inventive concepts.

### DETAILED DESCRIPTION

It should be understood that both the foregoing general description and the following detailed description are directed to some example embodiments of the inventive concepts. Reference characters are indicated in detail in some example embodiments of the inventive concepts, examples of which are indicated in the reference drawings. Wherever possible, the same reference numbers are used in the description and drawings to refer to the same or like parts.

When the terms “about” or “substantially” are used in this specification in connection with a numerical value, it is intended that the associated numerical value includes a manufacturing or operational tolerance (e.g., ±10%) around the stated numerical value. Moreover, when the words “generally” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes. When ranges are specified, the range includes all values therebetween such as increments of 0.1%.

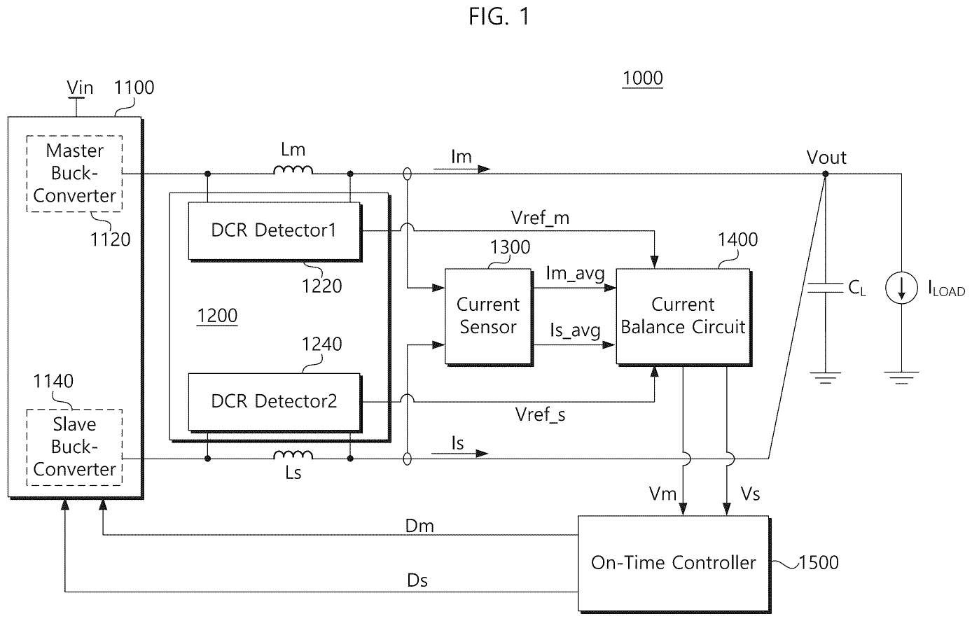

FIG. 1 is a block diagram showing the configuration of a dual-phase buck-converter according to an some example embodiments of the inventive concepts. Referring to FIG. 1, a dual-phase buck-converter 1000 may include a master inductor Lm, a slave inductor Ls, a buck-converter 1100, a DC resistance detection unit 1200, a current sensor 1300, a current balance circuit 1400, and an on-time controller 1500.

The buck-converter 1100 switches an input voltage Vin according to duty control signals Dm and Ds and transmits the input voltage Vin to the inductors Lm and Ls. The buck-converter 1100 may include a master buck-converter 1120 and a slave buck-converter 1140. The master buck-converter 1120 switches the input voltage Vin according to the master duty control signal Dm. The slave buck-converter 1140 switches the input voltage Vin according to the slave duty control signal Ds. The input voltage Vin switched by the master buck-converter 1120 and the slave buck-converter 1140 is applied to the master inductor Lm and the slave inductor Ls, respectively. The structure of the buck-converter 1100 will be described in more detail with reference to the drawings described below.

The inductors Lm and Ls transfer the master inductor current Im and the slave inductor current Is to the output terminal Vout where the load exists by the voltage switched in each of the master buck-converter 1120 and the slave buck-converter 1140. The load current ILOAD of the output terminal is expressed as the sum of the master inductor current Im and the slave inductor current Is.

The DC resistance detection unit 1200 detects the DC resistance DCR of the inductors Lm and Ls. The DC resistance detection unit 1200 may output the detected DC resistance DCR of each of the inductors Lm and Ls as reference voltages Vref_m and Vref_s. The DC resistance detection unit 1200 may include a first DC resistance detector 1220 and a second DC resistance detector 1240. The first DC resistance detector 1220 detects the DC resistance DCR of the master inductor Lm. The first DC resistance detector 1220 may generate a master reference voltage Vref_m corresponding to the DC resistance DCR of the master inductor Lm and provide the master reference voltage Vref_m to the current balance circuit 1400. The second DC resistance detector 1240 detects the DC resistance DCR of the slave inductor Ls. The second DC resistance detector 1240 may generate a slave reference voltage Vref_s corresponding to the DC resistance DCR of the slave inductor Ls and provide the slave reference voltage Vref_s to the current balance circuit 1400. A configuration of the DC resistance detection unit 1200 according to some example embodiments will be described in more detail in the drawings below.

The current sensor 1300 senses the current flowing in each of the master inductor Lm and the slave inductor Ls. The current sensor 1300 senses the master inductor current Im to generate the master average current Im_avg. The current sensor 1300 provides the master average current Im_avg to the current balance circuit 1400 to support the current balance operation. The current sensor 1300 senses the slave inductor current Is to output the slave average current Is_avg. The current sensor 1300 provides the slave average current Is_avg to the current balance circuit 1400 to support the balance operation of the current flowing in each of the master inductor Lm and the slave inductor Ls.

The current balance circuit 1400 performs a current balance operation to match the inductor currents Im and Is flowing in each of the master inductor Lm and the slave inductor Ls to the same level. The current balancing mechanism of the dual-phase buck-converter 1000 is performed by comparing the size (e.g., the levels) of the master average current Im_avg and the slave average current Is_avg to remove the offset. For example, the current balance circuit 1400 generates on-time control voltages Vm and Vs using the master average current Im_avg, the slave average current Is_avg, and the master reference voltage Vref_m and the slave reference voltage Vref_s. The on-time control voltages Vm and Vs are generated according to the reference voltages Vref_m and Vref_s that reflect (e.g., indicate) the magnitude of the DC resistance DCR of each of the inductors Lm and Ls. The DC resistance DCR of each of the inductors Lm and Ls may be different in magnitude. However, the current balance circuit 1400 is capable of generating on-time control voltages Vm and Vs to maintain the inductor currents Im and Is flowing through the master inductor Lm and the slave inductors (Ls) to be of equal level.

The on-time controller 1500 generates a master duty control signal Dm and a slave duty control signal Ds using the on-time control voltages Vm and Vs. The master reference voltage Vref_m and the slave reference voltage Vref_s may be generated according to the magnitude of the DC resistance DCR of each of the inductors Lm and Ls. Therefore, the on-time control voltages Vm and Vs may reflect a change in the magnitude of the DC resistance DCR of each of the variable inductors Lm and Ls. The on-time controller 1500 generates the master duty control signal Dm and the slave duty control signal Ds by changing the level of the on-time control voltages Vm and Vs along the time axis. For example, a master duty control signal Dm and a slave duty control signal Ds having a length corresponding to each of the on-time control voltages Vm and Vs may be generated using a ramp function of a desired (and/or predefined) time axis slope. The balance of the switching current by the master buck-converter 1120 and the slave buck-converter 1140 may be implemented by the master duty control signal Dm and the slave duty control signal Ds.

According to the dual-phase buck-converter 1000 of the inventive concepts described above, the current balance operation may be performed by reflecting the magnitude of the DC resistance DCR of the master inductor Lm and the slave inductor Ls. A dual-phase buck-converter 1000 may thus be implemented in which current balance may be maintained even when the DC resistances DCR of the master inductor Lm and the slave inductor Ls change. Therefore, the dual-phase buck-converter 1000 may actively cope with a decrease in power efficiency and/or required performance of the dual-phase buck-converter 1000 caused by current imbalance. Dual-phase buck-converter 1000 having improved efficiency and/or performance may thus be provided.

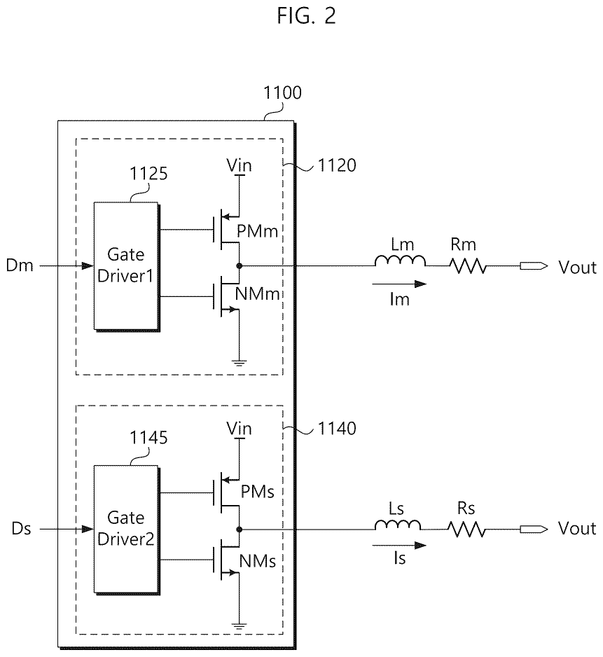

FIG. 2 is a schematic diagram showing a configuration of the buck-converter of FIG. 1 according to some example embodiments. Referring to FIG. 2, the buck-converter 1100 may include a master buck-converter 1120 and a slave buck-converter 1140. The master buck-converter 1120 supplies a master inductor current Im to the master inductor Lm according to a master duty control signal Dm. The slave buck-converter 1140 supplies a slave inductor current Is to the slave inductor Ls based on a slave duty control signal Ds. Here, each of the master inductor Lm and the slave inductor Ls may have DC resistances Rm and Rs.

The master buck-converter 1120 may include a first gate driver 1125 and master switching transistors PMm and NMm for switching the current of the master inductor Lm. The master switching transistors PMm and NMm may include a first pull-up transistor PMm and a first pull-down transistor NMm. The first pull-up transistor PMm switches on to connect the input voltage Vin to the master inductor Lm to increase the master inductor current Im supplied to the load side through the master inductor Lm. On the other hand, the first pull-down transistor NMm switches between one end of the master inductor Lm and ground to decrease the master inductor current Im supplied to the load side through the master inductor Lm.

The first gate driver 1125 controls the first pull-up transistor PMm and the first pull-down transistor NMm in response to the master duty control signal Dm. For example, the first gate driver 1125 may control the first pull-up transistor PMm and the first pull-down transistor NMm based on the master duty control signal Dm that varies depending on the magnitude of the master DC resistance Rm, which is the DC resistance of the master inductor Lm.

The slave buck-converter 1140 may include the second gate driver 1145 and slave switching transistors PMs and NMs for switching the current of the slave inductor Ls. The slave switching transistors PMs and NMs may include the second pull-up transistor PMs and the second pull-down transistor NMs. The second pull-up transistor PMs switches on to connect the input voltage Vin to the slave inductor Ls to increase the slave inductor current Is supplied to the load side through the slave inductor Ls. On the other hand, the second pull-down transistor NMs switches between one end of the slave inductor Ls and ground to decrease the forward current of the slave inductor current Is supplied to the load side through the slave inductor Ls.

The second gate driver 1145 controls the second pull-up transistor PMs and the second pull-down transistor NMs in response to the slave duty control signal Ds. For example, the second gate driver 1145 may control the second pull-up transistor PMs and the second pull-down transistor NMs based on the slave duty control signal Ds that varies depending on the magnitude of the slave DC resistance Rs of the slave inductor Ls.

As described above, the buck-converter 1100 of the inventive concepts is driven by the master duty control signal Dm and the slave duty control signal Ds that are generated for current balance based on the DC resistance values of the master inductor Lm and the slave inductor Ls, respectively. Therefore, the buck-converter 1100 of the inventive concepts may easily achieve balance of the master inductor current Im and the slave inductor current Is even under the conditions of the master inductor Lm and the slave inductor Ls having different DC resistance characteristics.

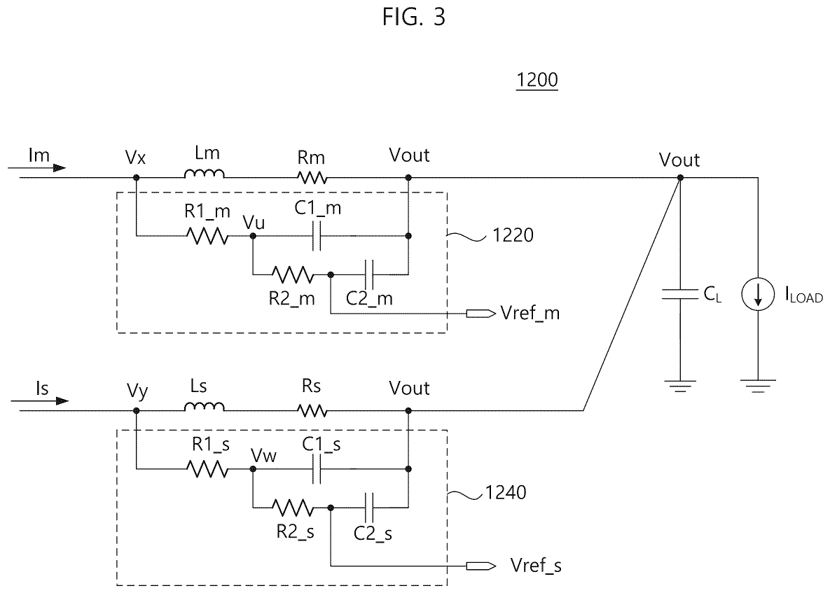

FIG. 3 is a circuit diagram showing a structure of a DC resistance detection unit of the inventive concepts illustrated in FIG. 1. Referring to FIG. 3, a DC resistance detection unit 1200 includes a first DC resistance detector 1220 and a second DC resistance detector 1240.

The first DC resistance detector 1220 generates a master reference voltage Vref_m that reflects the magnitude of the master DC resistance Rm corresponding to the DC resistance value of the master inductor Lm. The first DC resistance detector 1220 may be configured as a voltage distribution circuit or an RC filter circuit for generating a master reference voltage Vref_m that varies according to the magnitude of the master DC resistance Rm. Using the Laplace transform technique, the size of the master inductor current Im flowing through the impedance ‘Rm+sLm’ may be calculated (e.g., determined) by the voltage difference ‘Vx-Vout’. The first divided voltage ‘Vu’ may be calculated (e.g., determined) by the first resistor ‘R1_m’ and the first capacitor ‘C1_m’. Then, if the difference between the first divided voltage ‘Vu’ and the output voltage ‘Vout’ is divided by the second resistor ‘R2_m’ and the second capacitor ‘C2_m’, the master reference voltage Vref_m may be expressed by the following Equation 1.

$$Vref\_m = V out + Im\_dc \times Rm \qquad [ Equation 1 ]$$

According to Equation 1, the master reference voltage Vref_m may be composed of the output voltage ‘Vout’ and the master DC resistance ‘Rm’ term. Here, the master DC current Im_dc may mean the master inductor current Im with the ripple removed by filtering of the second resistor R2_m and the second capacitor C2_m. Therefore, it may be seen that the master reference voltage Vref_m depends on the magnitude of the master DC resistance Rm included in the master inductor Lm.

Similarly, the second DC resistance detector 1240 generates a slave reference voltage Vref_s that reflects the magnitude of the slave DC resistance Rs corresponding to the DC resistance of the slave inductor Ls. The second DC resistance detector 1240 may also be configured as a voltage distribution circuit or an RC filter circuit to generate a slave reference voltage Vref_s that varies according to the magnitude of the slave DC resistance Rs, similar to the first DC resistance detector 1220. The size of the slave inductor current Is flowing through the impedance ‘Rs+sLs’ may be calculated (e.g., determined) by the voltage difference ‘Vy−Vout’. The second divided voltage ‘Vw’ may be calculated (e.g., determined) by the third resistor ‘R1_s’ and the third capacitor ‘C1_s’. Then, if the difference between the second divided voltage ‘Vw’ and the output voltage ‘Vout’ is divided by the fourth resistor ‘R2_s’ and the fourth capacitor ‘C2_s’, the slave reference voltage Vref_s may be expressed by the following Equation 2.

$$Vref\_s = V out + Is\_dc \times Rs \qquad [ Equation 2 ]$$

According to Equation 2, the slave reference voltage Vref_s may be composed of the output voltage ‘Vout’ and the slave DC resistance ‘Rs’ terms. Here, the slave DC current Is_dc may mean the slave inductor current Is with the ripple removed by filtering of the fourth resistor ‘R2_s’ and the fourth capacitor ‘C2_s’. Therefore, it may be seen that the slave reference voltage Vref_s reflects the magnitude of the slave DC resistance Rs included in the slave inductor Ls.

In the above, some example embodiments of a method of generating the master reference voltage Vref_m and the slave reference voltage Vref_s by the first DC resistance detector 1220 and the second DC resistance detector 1240 has been explained using FIG. 3. However, methods of generating the master reference voltage Vref_m and the slave reference voltage Vref_s reflecting the magnitudes of the master DC resistance Rm and the slave DC resistance Rs respectively is not limited to the disclosure herein. It will be well understood that the generation of the master reference voltage Vref_m and the slave reference voltage Vref_s reflecting the magnitudes of the master DC resistance Rm and the slave DC resistance Rs respectively is possible in various ways.

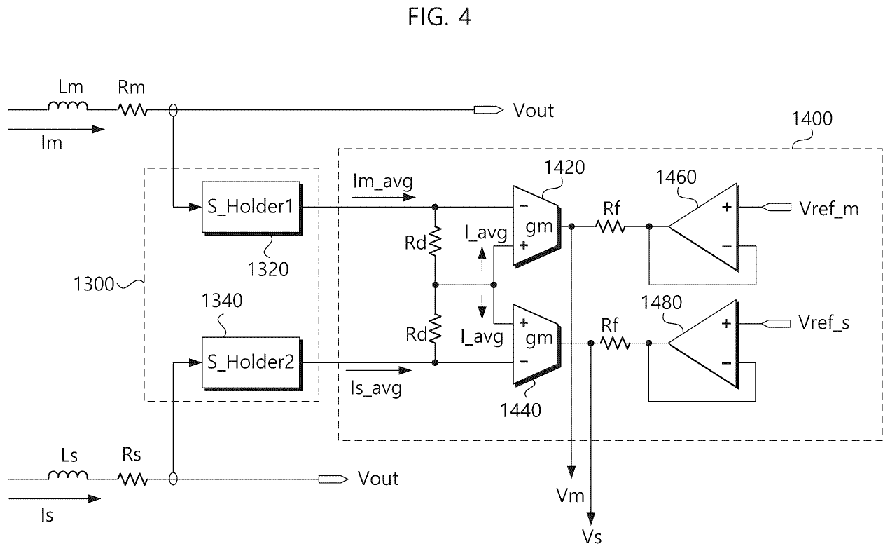

FIG. 4 is a diagram showing the current sensor and current balance circuit of FIG. 1 according to some example embodiments. Referring to FIG. 4, the current sensor 1300 may include first and second sample-holders 1320 and 1340. The current balance circuit 1400 may include distribution resistors Rd, filter resistors Rf, trans-conductors 1420 and 1440, and buffers 1460 and 1480.

The current sensor 1300 includes a first sample-holder 1320 for sensing a master inductor current Im. The first sample-holder 1320 may sense the size of the master inductor current Im and output it as a master average current Im_avg. The second sample-holder 1340 senses the slave average current Is_avg. The second sample-holder 1340 may sense the size of the slave inductor current Is and output it as the slave average current Is_avg.

The current balance circuit 1400 compares the master average current Im_avg and the slave average current Is_avg to generate on-time control voltages Vm and Vs. The current balance circuit 1400 may generate on-time control voltages Vm and Vs to compensate for the difference between the master average current Im_avg and the slave average current Is_avg by using the master reference voltage Vref_m and the slave reference voltage Vref_s detected from the master DC resistance Rm and the slave DC resistance Rs.

A size of 0.5 times the master average current Im_avg is input to the negative input terminal (−) of the first trans-conductor 1420, and an average current I_avg of the master average current Im_avg and the slave average current Is_avg is input to the positive input terminal (+). Here, the average current I_avg may be provided to the positive input terminals (+) of the first trans-conductor 1420 and the second trans-conductor 1440 with the same size of ‘0.5×(Im_avg+Is_avg)’ by the distribution resistors Rd. The first trans-conductor 1420 may provide a voltage corresponding to the differential current ‘I_avg−0.5×Im_avg’ of the positive input terminal (+) and the negative input terminal (−) as an output. A voltage output from the first trans-conductor 1420 and the master reference voltage Vref_m provided through a feedback resistor Rf and a first buffer 1460 are added at the output terminal of the first trans-conductor 1420. Considering these conditions, the master on-time control voltage Vm formed at the output terminal of the first trans-conductor 1420 may be expressed by the following Equation 3.

$$V m = 0.5 \times ( - Im\_avg + Is\_avg ) \times g m \times R f + Vref\_m \qquad [ Equation 3 ]$$

If the master reference voltage Vref_m term of Equation 3 is replaced with Equation 1, it may be expressed by the following Equation 4.

$$V m = 0.5 \times ( - Im\_avg + Is\_avg ) \times gm \times Rf + V out + Im\_dc \times Rm \qquad [ Equation 4 ]$$

Considering Equation 4, the master on-time control voltage Vm includes an average current term, an output voltage Vout term, and a master DC resistance Rm term. For example, this means that the master on-time control voltage Vm may be provided as a value that reflects the magnitude of the master DC resistance Rm.

A size of 0.5 times the slave average current Is_avg is input to the negative input terminal (−) of the second trans-conductor 1440, and an average current I_avg of the master average current Im_avg and the slave average current Is_avg is input to the positive input terminal (+). Here, the average current I_avg may be provided to the positive input terminals (+) of the first trans-conductor 1420 and the second trans-conductor 1440 with the same size of ‘0.5×(Im_avg+Is_avg)’ by the distribution resistors Rd as mentioned above. The second trans-conductor 1440 may provide a voltage corresponding to the differential current ‘I_avg−0.5×Is_avg’ of the positive input terminal (+) and the negative input terminal (−) as an output. A voltage output from the second trans-conductor 1440 and the slave reference voltage Vref_s provided through a feedback resistor Rf and a second buffer 1480 are added at the output terminal of the second trans-conductor 1440. Considering these conditions, the slave on-time control voltage Vs formed at the output terminal of the second trans-conductor 1440 may be expressed by the following Equation 5.

$$V s = 0.5 \times ( - Is\_avg + Im\_avg ) \times g m \times Rf + V ref\_s \qquad [ Equation 5 ]$$

If the slave reference voltage Vref_s term of Equation 5 is replaced with Equation 2, it may be expressed by the following Equation 6.

$$V s = 0.5 \times ( - Is\_avg + Im\_avg ) \times g m \times Rf + V out + Is\_dc \times Rs \qquad [ Equation 6 ]$$

According to Equation 6, the slave on-time control voltage Vs includes an average current term, an output voltage Vout term, and a slave DC resistance Rs term. For example, this means that the slave on-time control voltage Vs may be provided as a value that reflects the magnitude of the slave DC resistance Rs.

The output voltage Vout formed at the output terminal may be expressed by the following Equations 7 and 8.

$$\begin{matrix}V out = Dm \times V in - Im \times Rm \\ = 0.5 \times ( - Im\_avg + Is\_avg ) \times gm \times Rf + V out\end{matrix} \qquad [ Equation 7 ]$$

$$\begin{matrix}V out = Ds \times V in - Is \times Rs \\ = 0.5 \times ( Im\_avg - Is\_avg ) \times gm \times Rf + V out\end{matrix} \qquad [ Equation 8 ]$$

In order to satisfy the above Equations 7 and 8, the master average current Im_avg and the slave average current Is_avg must be equal. Therefore, when switching is performed by the master duty control signal Dm and the slave duty control signal Ds of some example embodiments of the inventive concepts, it may be seen that the master inductor current Im and the slave inductor current Is may be balanced. In conclusion, the balance of the master inductor current Im and the slave inductor current Is may be implemented as in the following Equation 9.

$$Im = Is = 0.5 \times {I}_{LOAD} \qquad [ Equation 9 ]$$

According to the above explanation, the current balance circuit 1400 of the inventive concepts uses the master reference voltage Vref_m and the slave reference voltage Vref_s detected from the master DC resistance Rm and the slave DC resistance Rs. Therefore, the current balance circuit 1400 may generate on-time control voltages Vm and Vs to compensate for the difference between the master average current Im_avg and the slave average current Is_avg by reflecting the sizes of the master DC resistance Rm and the slave DC resistance Rs.

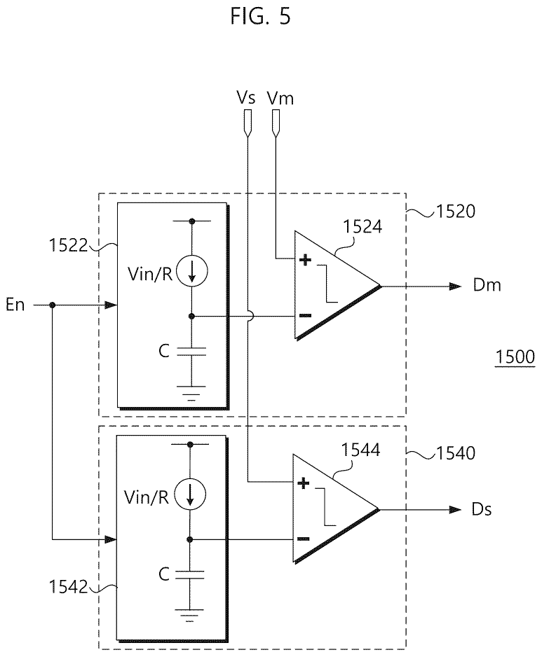

FIG. 5 is a drawing showing an on-time controller in FIG. 1 according to some example embodiments. Referring to FIG. 5, the on-time controller 1500 includes a master on-time controller 1520 and a slave on-time controller 1540.

The master on-time controller 1520 generates a master duty control signal Dm using a master on-time control voltage Vm. For example, the master on-time controller 1520 may include a first ramp generator 1522 and a first comparator 1524. The first ramp generator 1522 generates a ramp signal with a slope of ‘Vin/(RC)’ on the time axis in response to an enable signal En. The ramp signal with a slope of ‘Vin/(RC)’ is transmitted to the negative input terminal (−) of the first comparator 1524.

The first comparator 1524 compares the master on-time control voltage Vm with the ramp signal of slope ‘Vin/(RC)’ to generate the master duty control signal Dm. If the master on-time control voltage Vm is greater than the ramp signal, the first comparator 1524 will generate the master duty control signal Dm of high level ‘H’. On the other hand, if the master on-time control voltage Vm is less than the ramp signal, the first comparator 1524 will generate the master duty control signal Dm of low level ‘L’.

The slave on-time controller 1540 generates the slave duty control signal Ds using the slave on-time control voltage Vs. For example, the slave on-time controller 1540 may include a second ramp generator 1542 and a second comparator 1544. The second ramp generator 1542 generates a ramp signal with a slope of ‘Vin/(RC)’ on the time axis in response to the enable signal En. The ramp signal with a slope of ‘Vin/(RC)’ is transmitted to the negative input terminal (−) of the second comparator 1544.

The second comparator 1544 compares the slave on-time control voltage Vs with the ramp signal with a slope of ‘Vin/(RC)’ to generate a slave duty control signal Ds. If the slave on-time control voltage Vs is greater than the ramp signal, the second comparator 1544 will generate a slave duty control signal Ds with a high level ‘H’. On the other hand, if the slave on-time control voltage Vs is less than the ramp signal, the second comparator 1544 will generate a slave duty control signal Ds with a low level ‘L’. The generation characteristics of the master duty control signal Dm and the slave duty control signal Ds of the master on-time controller 1520 and the slave on-time controller 1540 will be described in more detail through the waveform diagram described below.

In the configuration of the on-time controller 1500 of some example embodiments of the inventive concepts as described above, the on-time controller 1500 may generate the master duty control signal Dm and the slave duty control signal Ds from the master on-time control voltage Vm and the slave on-time control voltage Vs determined according to the magnitudes of the master DC resistance Rm and the slave DC resistance Rs. Therefore, even if the master DC resistance Rm and the slave DC resistance Rs are different, it is possible to match the master average current Im_avg and the slave average current Is_avg to the same level through the master duty control signal Dm and the slave duty control signal Ds.

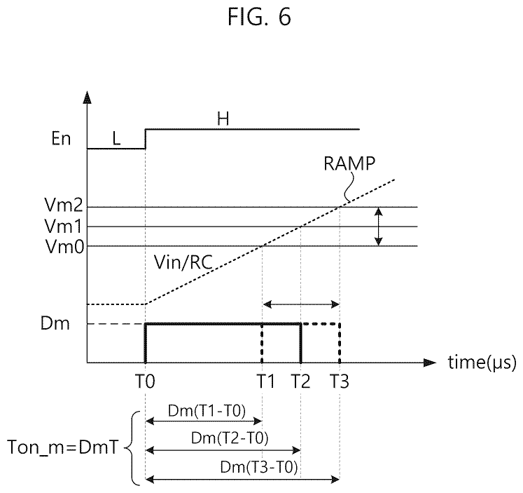

FIG. 6 is a waveform diagram showing the operation of the master on-time controller of FIG. 5. Referring to FIG. 6, the master on-time controller 1520 generates the master duty control signal Dm in response to the master on-time control voltage Vm and the enable signal En.

At time T0, when the enable signal En is activated to a high level ‘H’, the first ramp generator 1522 generates a ramp signal RAMP with a slope of ‘Vin/(RC)’ with respect to the time axis. The ramp signal RAMP is provided to the negative input terminal (−) of the first comparator 1524. When the levels of the master on-time control voltage Vm transmitted to the positive input terminal (+) of the first comparator 1524 are ‘Vm0’, ‘Vm1’, and ‘Vm2’, respectively, the duty size of the master duty control signal Dm changes.

When the level of the master on-time control voltage Vm is ‘Vm0’, when the time point T1 is reached, the size of the ramp signal RAMP becomes higher than that of the master on-time control voltage Vm. Therefore, the time axis length of the master duty control signal Dm will correspond to ‘T1-T0’. For example, the on-time period of the master duty control signal Dm is output as ‘T1-T0’.

When the level of the master on-time control voltage Vm is ‘Vm1’, when the time point T2 is reached, the size of the ramp signal RAMP becomes higher than the master on-time control voltage Vm. Therefore, the time axis length of the master duty control signal Dm will correspond to ‘T2-T0’. The on-time period of the master duty control signal Dm is output as ‘T2-T0’.

When the level of the master on-time control voltage Vm is ‘Vm2’, when the time point T3 is reached, the size of the ramp signal RAMP becomes higher than the master on-time control voltage Vm. Therefore, the time axis length of the master duty control signal Dm will correspond to ‘T3-T0’. For example, the on-time period of the master duty control signal Dm is output as ‘T3-T0’.

As illustrated, the master duty control signal Dm may be generated from the master on-time control voltage Vm that reflects the magnitude of the master DC resistance Rm. Accordingly, it may be seen that control of the master average current Im_avg is possible through the master duty control signal Dm that is adjusted according to the magnitude of the master DC resistance Rm.

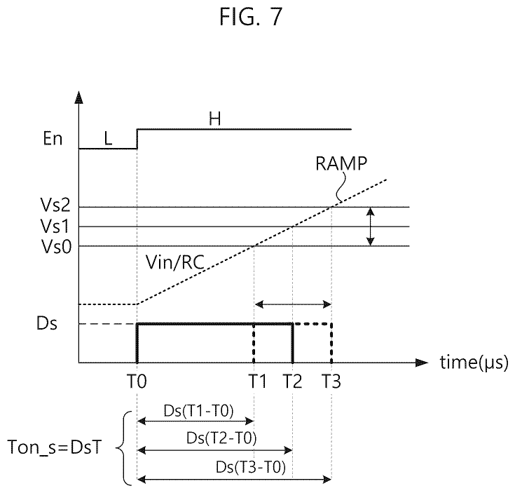

FIG. 7 is a waveform diagram showing the operation of the slave on-time controller of FIG. 5. Referring to FIG. 7, the slave on-time controller 1540 generates a slave duty control signal Ds in response to the slave on-time control voltage Vs and the enable signal En.

At time T0, when the enable signal En is activated to a high level ‘H’, the second ramp generator 1542 generates a ramp signal RAMP with a slope of ‘Vin/(RC)’ with respect to the time axis. The ramp signal RAMP is provided to the negative input terminal (−) of the second comparator 1544. When the levels of the slave on-time control voltage Vs transmitted to the positive input terminal (+) of the second comparator 1544 are ‘Vs0’, ‘Vs1’, and ‘Vs2’, respectively, the duty size of the slave duty control signal Ds changes.

When the level of the slave on-time control voltage Vs is ‘Vs0’, when the time point T1 is reached, the size of the ramp signal RAMP becomes higher than the slave on-time control voltage Vs. Therefore, the time axis length of the slave duty control signal Ds will correspond to ‘T1-T0’. For example, the on-time period of the slave duty control signal Ds is output as ‘T1-T0’.

When the level of the slave on-time control voltage Vs is ‘Vs1’, when the time point T2 is reached, the size of the ramp signal RAMP becomes higher than that of the slave on-time control voltage Vs. Therefore, the time axis length of the slave on-time control voltage Vs will correspond to ‘T2-T0’. The on-time period of the slave duty control signal Ds is output as ‘T2-T0’.

When the level of the slave on-time control voltage Vs is ‘Vs2’, when the time point T3 is reached, the size of the ramp signal RAMP becomes higher than that of the slave on-time control voltage Vs. Therefore, the time axis length of the slave duty control signal Ds will correspond to ‘T3-T0’. For example, the on-time period of the slave duty control signal Ds is output as ‘T3-T0’.

As illustrated, the slave duty control signal Ds may be generated from the slave on-time control voltage Vs in which the size of the slave DC resistance Rs is reflected by the slave on-time controller 1540. Therefore, it may be seen that the slave average current Is_avg may be controlled through the slave duty control signal Ds adjusted according to the magnitude of the slave DC resistance Rs.

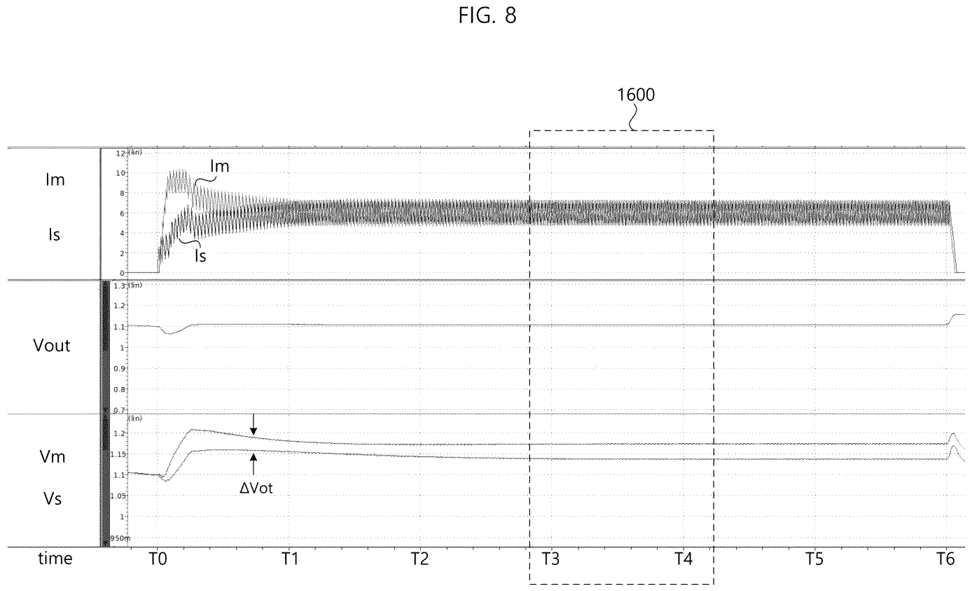

FIG. 8 is a waveform diagram showing the current balancing effect of the dual-phase buck-converter according to some example embodiments of the inventive concepts. Referring to FIG. 8, the dual-phase buck-converter 1000 of the inventive concepts may match the master inductor current Im and the slave inductor current Is by using the master DC resistance Rm and the slave DC resistance Rs. For example, the implementation of current balancing is possible.

At time T0, the driving of the dual-phase buck-converter 1000 starts. Then, the supply of the master inductor current Im and the slave inductor current Is by the buck-converter 1100 starts. The initial sizes of the master inductor current Im and the slave inductor current Is also show a difference due to the difference in the magnitudes of the DC resistances Rm and Rs of the master inductor Lm and the slave inductor Ls. The current balance circuit 1400 generates the master on-time control voltage Vm and the slave on-time control voltage Vs by using the master reference voltage Vref_m and the slave reference voltage Vref_s that reflect the difference in the magnitudes of the DC resistances Rm and Rs. The master on-time control voltage Vm and the slave on-time control voltage Vs will be generated while maintaining a constant voltage difference ΔVot. The on-time controller 1500 will generate the master duty control signal Dm and the slave duty control signal Ds to maintain current balance corresponding to the master on-time control voltage Vm and the slave on-time control voltage Vs.

At time T1, the master duty control signal Dm and the slave duty control signal Ds generated from the master on-time control voltage Vm and the slave on-time control voltage Vs are provided to the master buck-converter 1120 and the slave buck-converter 1140, respectively. Then, the master buck-converter 1120 and the slave buck-converter 1140 will perform switching to match the master inductor current Im and the slave inductor current Is. Therefore, the balance of the master inductor current Im and the slave inductor current Is begins to occur from the time point T1. This balance of the master inductor current Im and the slave inductor current Is is maintained constantly at the driving time of the dual-phase buck-converter 1000.

In the above, the current balance effect using the difference of the DC resistances Rm and Rs of the master inductor Lm and the slave inductor Ls of the dual-phase buck-converter 1000 of the inventive concepts has been explained.

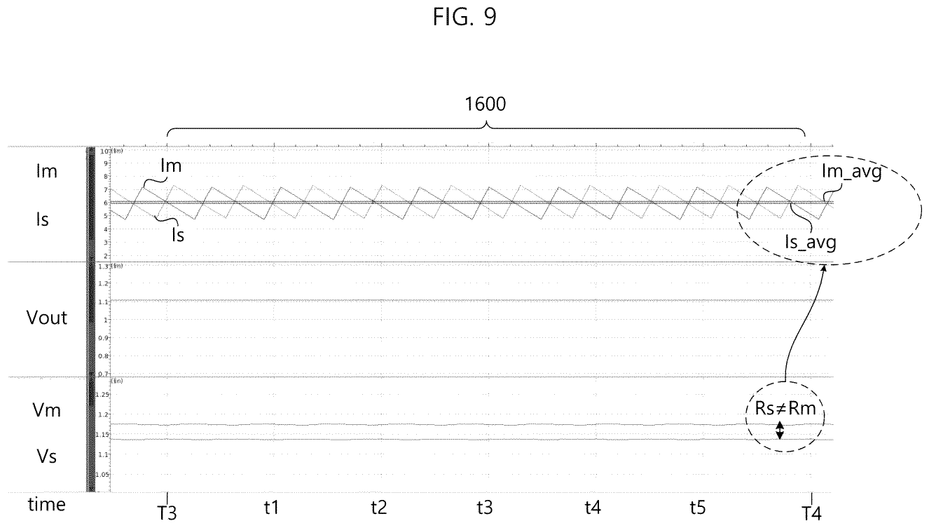

FIG. 9 is a waveform diagram showing the section between time points T3 and T4 of FIG. 8 in more detail. Referring to FIG. 9, it may be seen that the average currents of the master inductor current Im and the slave inductor current Is in the section between time points T3 and T4 (section 1600) are almost the same size.

The master inductor current Im and the slave inductor current Is may have ripples as they are switched by the master duty control signal Dm and the slave duty control signal Ds. However, since they are controlled to be mutually balanced by the on-time controller 1500, the master average current Im_avg and the slave average current Is_avg may maintain current balance to the extent that there is almost no difference. The output voltage Vout and the on-time control voltages Vm and Vs are the same or substantially the same as those of FIG. 8.

According to the waveform diagram above, the magnitudes of the master DC resistance Rm and the slave DC resistance Rs may be different (e.g., Rm≠Rs). However, by using the DC resistance detection unit 1200 of the inventive concepts, it is possible to generate the master reference voltage Vref_m and the slave reference voltage Vref_s that reflect the magnitudes of the master DC resistance Rm and the slave DC resistance Rs. The master duty control signal Dm and the slave duty control signal Ds for current balance may be generated from the master reference voltage Vref_m and the slave reference voltage Vref_s. The levels of the master average current Im_avg and the slave average current Is_avg may be balanced as illustrated by the master duty control signal Dm and the slave duty control signal Ds.

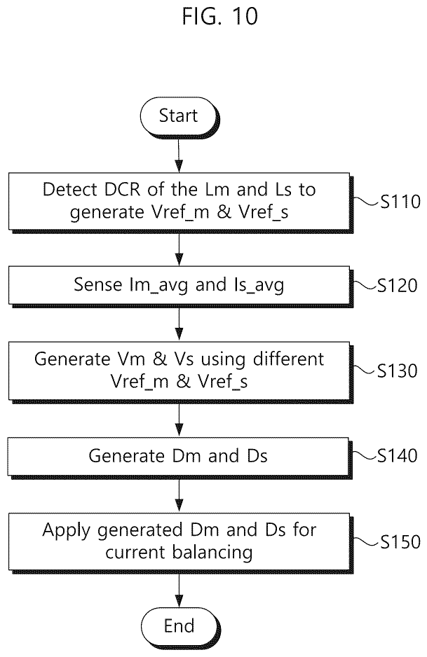

FIG. 10 is a flowchart showing a current balancing method of a dual-phase buck-converter according to some example embodiments of the inventive concepts. Referring to FIG. 10, the dual-phase buck-converter 1000 may detect the DC resistance of the master inductor Lm and the slave inductor Ls and use the DC resistance as a parameter for current balancing. When the dual-phase buck-converter 1000 is driven, the master inductor current Im and the slave inductor current Is of opposite phases will start to be supplied to the master inductor Lm and the slave inductor Ls, respectively.

In step S110, the DC resistance detection unit (1200, see FIG. 1) detects the DC resistance of each of the master inductor Lm and the slave inductor Ls. For example, the first DC resistance detector 1220 detects the master DC resistance Rm of the master inductor Lm. The detected master DC resistance Rm is generated as a master reference voltage Vref_m and provided to the current balance circuit (1400, see FIG. 1). For example, the master reference voltage Vref_m reflects (e.g., indicates) the detected master DC resistance Rm. The second DC resistance detector 1240 detects the slave DC resistance Rs of the slave inductor Ls. The detected slave DC resistance Rs is generated as a slave reference voltage Vref_s and provided to the current balance circuit 1400. For example, the slave reference voltage Vref_s reflects (e.g., indicates) the detected slave DC resistance Rs.

In step S120, the current sensor (1300, see FIG. 1) senses the current flowing in each of the master inductor Lm and the slave inductor Ls. The current sensor 1300 senses the master inductor current Im to generate the master average current Im_avg. The current sensor 1300 senses the slave inductor current Is to output the slave average current Is_avg.

In step S130, the current balance circuit 1400 generates on-time control voltages Vm and Vs using the master average current Im_avg, the slave average current Is_avg, the master reference voltage Vref_m and the slave reference voltage Vref_s. The on-time control voltages Vm and Vs are generated according to the reference voltages Vref_m and Vref_s that reflect the magnitudes of the DC resistances Rm and Rs of each of the inductors Lm and Ls. Even if the magnitudes of the DC resistances Rm and Rs of each of the inductors Lm and Ls are different, the current balance circuit 1400 may generate on-time control voltages Vm and Vs to maintain the inductor currents Im and Is flowing through the master inductor Lm and the slave inductor Ls to be of equal sizes.

In step S140, the on-time controller (1500, see FIG. 1) generates a master duty control signal Dm and a slave duty control signal Ds using the on-time control voltages Vm and Vs. The master reference voltage Vref_m and the slave reference voltage Vref_s may be varied depending on the magnitudes of the DC resistances Rm and Rs of each of the inductors Lm and Ls. Therefore, the on-time control voltages Vm and Vs may reflect the change in the magnitude of the DC resistances Rm and Rs of each of the inductors Lm and Ls. The on-time controller 1500 changes the size of the on-time control voltages Vm and Vs along the time axis to generate the master duty control signal Dm and the slave duty control signal Ds.

In step S150, the master duty control signal Dm and the slave duty control signal Ds are provided to the buck-converter 1100. Then, switching occurs for the input voltages of the master buck-converter 1120 and the slave buck-converter 1140 by the master duty control signal Dm and the slave duty control signal Ds. The master inductor current Im and the slave inductor current Is having the same average current value may be provided to the master inductor Lm and the slave inductor Ls.

In the above, the current balancing method using the difference of the DC resistances Rm and Rs of the master inductor Lm and the slave inductor Ls of the dual-phase buck-converter 1000 of the inventive concepts has been described. It will be well understood that the inventive concepts are not limited to the above-described order, and the order may be changed as needed.

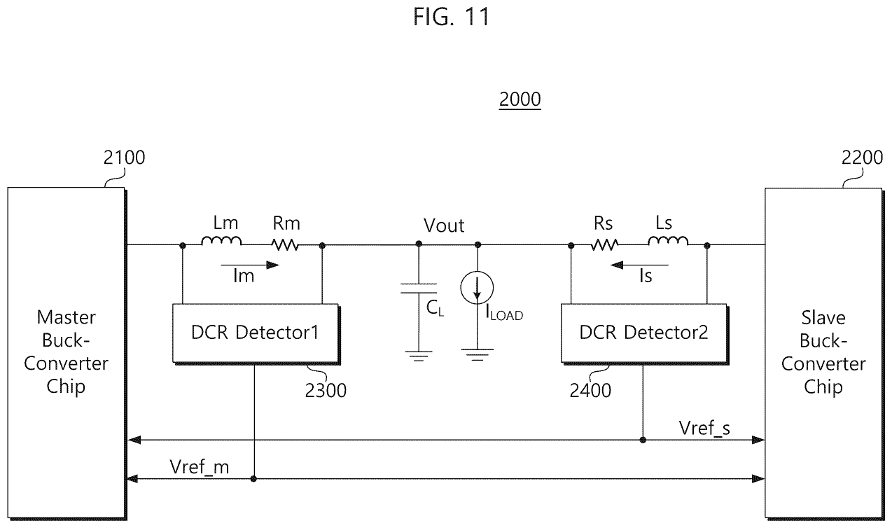

FIG. 11 is a diagram showing a dual-phase buck-converter according to some example embodiments of the inventive concepts. Referring to FIG. 11, the dual-phase buck-converter 2000 may supply a master inductor current Im and a slave inductor current Is to the load side from two different chips 2100 and 2200. For example, each of the master buck-converter chip 2100 and the slave buck-converter chip 2200 may perform a balancing operation of the master inductor current Im and the slave inductor current Is based on the master reference voltage Vref_m and the slave reference voltage Vref_s.

For example, a first DC resistance detector 2300 and a second DC resistance detector 2400 detect the DC resistances of each of the master inductor Lm and the slave inductor Ls. The first DC resistance detector 2300 detects the DC resistance Rm of the master inductor Lm. The first DC resistance detector 2300 generates a master reference voltage Vref_m corresponding to the DC resistance Rm of the master inductor Lm and provides it to the master buck-converter chip 2100 and the slave buck-converter chip 2200. The second DC resistance detector 2400 detects the DC resistance Rs of the slave inductor Ls. The second DC resistance detector 2400 generates a slave reference voltage Vref_s corresponding to the DC resistance Rs of the slave inductor Ls and provides it to the master buck-converter chip 2100 and the slave buck-converter chip 2200.

The master buck-converter chip 2100 and the slave buck-converter chip 2200 are each provided with a current sensor, a current balance circuit, and an on-time controller to generate a master duty control signal Dm and a slave duty control signal Ds. The current sensor of the master buck-converter chip 2100 may detect a master average current corresponding to an average value of the master inductor current Im based on the master inductor current, and the slave-buck converter chip 2200 may detect a slave average current corresponding to an average value of the slave inductor current Is based on the slave inductor current. The master buck-converter chip 2100 may supply the master inductor current Im by switching the input voltage Vin according to the generated master duty control signal Dm. The slave buck-converter chip 2200 may supply the slave inductor current Is by switching the input voltage Vin according to the generated slave duty control signal Ds.

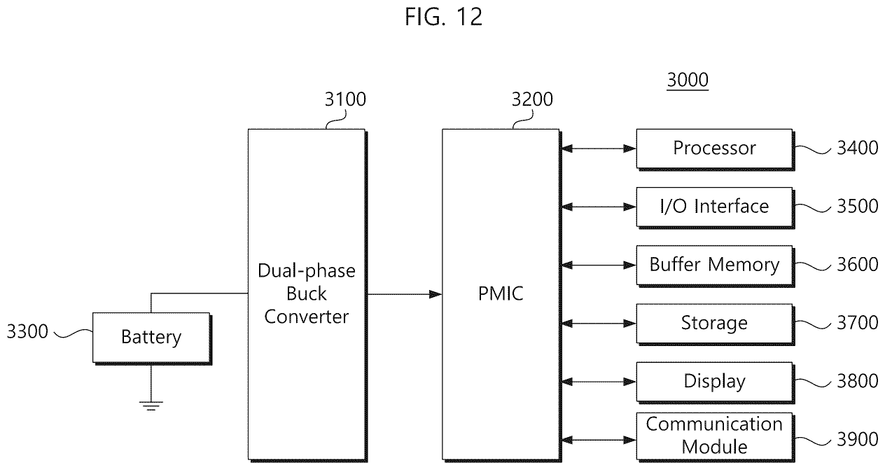

FIG. 12 is a block diagram showing a mobile device (e.g., a mobile electronic device) including a dual-phase buck-converter according to some example embodiments of the inventive concepts. Referring to FIG. 12, the mobile device 3000 may include a dual-phase buck-converter 3100, a power management IC 3200, a battery 3300, a processor 3400, an input/output interface 3500, a buffer memory 3600, a storage 3700, a display 3800, and a communication module 3900.

The dual-phase buck-converter 3100 may perform a current balance operation by reflecting the size of the DC resistance DCR of the master inductor Lm and the slave inductor Ls. Therefore, it is possible to implement a dual-phase buck-converter 3100 in which the current balance may be maintained even when the DC resistance DCR of the master inductor Lm and the slave inductor Ls change. The dual-phase buck-converter 3100 may actively cope with the power efficiency reduction and/or required performance reduction caused by the current imbalance.

The power management IC 3200 may receive power from the dual-phase buck-converter 3100. For example, the power management IC 3200 may convert the voltage provided from the dual-phase buck-converter 3100 into a stable voltage. The power management IC 3200 may provide a stable voltage to other components of the mobile electronic device. For example, each of the processor 3400, the input/output interface 3500, the buffer memory 3600, the storage 3700, the display 3800, and the communication module 3900 included in the mobile electronic device may operate using respective different stable component voltages provided from the power management IC 3200.

Each of the dual-phase buck-converter 3100 or the power management IC 3200 may be implemented as an integrated circuit chip. Each of the dual-phase buck-converter 3100 or the power management IC 3200 may be mounted using various types of semiconductor packages. For example, each of the dual-phase buck-converter 3100 or the power management IC 3200 may be mounted using a package such as a POP (Package on Package), BGAs (Ball Grid Arrays), CSPs (Chip Scale Packages), PLCC (Plastic Leaded Chip Carrier), PDIP (Plastic Dual In-line Package), Die in Waffle Pack, Die in Wafer Form, COB (Chip On Board), CERDIP (Ceramic Dual In-line Package), MQFP (Metric Quad Flat Pack), TQFP (Thin Quad Flat Pack), SOIC (Small Outline Integrated Circuit), SSOP (Shrink Small Outline Package), TSOP (Thin Small Outline Package), SIP (System In Package), MCP (Multi Chip Package), WFP (Wafer-level Fabricated Package), or WSP (Wafer-Level Processed Stack Package).

One or more of the elements disclosed above may include or be implemented in processing circuitry such as hardware including logic circuits; a hardware/software combination such as a processor executing software; or a combination thereof. For example, the processing circuitry may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, an application-specific integrated circuit (ASIC), etc.

Although some example embodiments for carrying out the inventive concepts have been described, some other example embodiments of the inventive concepts may include simple design changes or easily changeable variations. The inventive concepts may include variations of some example embodiments and/or techniques that can be easily modified and implemented. Therefore, the scope of the inventive concepts should not be limited to the above-described some example embodiments, and should be defined by the claims and equivalents of the claims.

What is claimed is:

1. A dual-phase buck-converter, comprising:
a first inductor configured to transmit a master inductor current having a first phase to a load;
a second inductor configured to transmit a slave inductor current having a second phase to the load;
a DC resistance detection circuit configured to
detect a DC resistance of the first inductor and generate a first reference voltage indicative of the DC resistance of the first inductor, and
detect a DC resistance of the second inductor and generate a second reference voltage indicative of the DC resistance of the second inductor;
a current sensor configured to detect a master average current corresponding to an average value of the master inductor current, and detect a slave average current corresponding to an average value of the slave inductor current;
a current balance circuit configured to generate a master on-time control voltage and a slave on-time control voltage for controlling matching of the master average current and the slave average current, based on the first reference voltage and the second reference voltage;
an on-time controller configured to generate a master duty signal and a slave duty signal based on the master on-time control voltage and the slave on-time control voltage; and
a buck-converter configured to supply the master inductor current for the first inductor based on the master duty signal, and supply the slave inductor current for the second inductor based on the slave duty signal.

2. The dual-phase buck-converter of claim 1, wherein the DC resistance detection circuit comprises:
a first filter circuit connected in parallel to both ends of the first inductor, the first filter circuit configured to convert the DC resistance of the first inductor into the first reference voltage; and
a second filter circuit connected in parallel to both ends of the second inductor, the second filter circuit configured to convert the DC resistance of the second inductor into the second reference voltage.

3. The dual-phase buck-converter of claim 2, wherein the first filter circuit and the second filter circuit include resistor-capacitor filters.

4. The dual-phase buck-converter of claim 1, wherein the current balance circuit comprises:
a first trans-conductor configured to generate a first voltage corresponding to a difference between half of the master average current and a reference current value;
a first buffer configured to buffer the first reference voltage; and
a first feedback resistor configured to add the first reference voltage buffered by the first buffer to the first voltage to provide the master on-time control voltage.

5. The dual-phase buck-converter of claim 4, wherein the current balance circuit further comprises:
a second trans-conductor configured to generate a second voltage corresponding to a difference between half of the slave average current and the reference current value;
a second buffer configured to buffer the second reference voltage; and
a second feedback resistor configured to add the second reference voltage buffered by the second buffer to the second voltage to provide the slave on-time control voltage.

6. The dual-phase buck-converter of claim 5, wherein the reference current value corresponds to an average current value of the master average current and the slave average current.

7. The dual-phase buck-converter of claim 4, wherein the on-time controller comprises:
a first ramp generator configured to generate a first ramp signal having a first slope;
a first comparator configured to generate the master duty signal by comparing the first ramp signal with the master on-time control voltage;
a second ramp generator configured to generate a second ramp signal having the first slope; and
a second comparator configured to generate the slave duty signal by comparing the second ramp signal with the slave on-time control voltage.

8. The dual-phase buck-converter of claim 1, wherein the buck-converter comprises:
a master buck-converter configured to supply the master inductor current to the first inductor by switching an input voltage based on to the master duty signal; and
a slave buck-converter configured to supply the slave inductor current to the second inductor by switching the input voltage based on the slave duty signal.

9. A dual-phase buck-converter, comprising:
a first buck-converter configured to generate a master inductor current having a first phase;
a first inductor configured to transmit the master inductor current from the first buck-converter to a load;
a second buck-converter configured to generate a slave inductor current having a second phase;
a second inductor configured to transmit the slave inductor current from the second buck-converter to the load;
a first DC resistance detector configured to detect a first DC resistance of the first inductor and generate a first reference voltage indicative of the first DC resistance;
a second DC resistance detector configured to detect a second DC resistance of the second inductor and generate a second reference voltage indicative of the second DC resistance; and
a current balance circuit configured to generate a master on-time control voltage and a slave on-time control voltage for controlling balancing of the master inductor current and the slave inductor current, based on the first reference voltage and the second reference voltage,
wherein the first buck-converter is configured to generate the master inductor current based on the master on-time control voltage, and
the second buck-converter is configured to generate the slave inductor current based on the slave on-time control voltage.

10. The dual-phase buck-converter of claim 9, further comprising:
a current sensor configured to detect a master average current corresponding to an average value of the master inductor current flowing in the first inductor, and detect a slave average current corresponding to an average value of the slave inductor current flowing in the second inductor.

11. The dual-phase buck-converter of claim 10, wherein the current balance circuit comprises:
a first trans-conductor configured to generate a first voltage corresponding to a difference between half of the master average current and a reference current value;
a first buffer configured to buffer the first reference voltage; and
a first feedback resistor configured to add the first reference voltage buffered by the first buffer to the first voltage to provide the master on-time control voltage.

12. The dual-phase buck-converter of claim 11, wherein the current balance circuit further comprises:
a second trans-conductor configured to generate a second voltage corresponding to a difference between half of the slave average current and the reference current value;
a second buffer configured to buffer the second reference voltage; and
a second feedback resistor configured to add the second reference voltage buffered by the second buffer to the second voltage to provide the slave on-time control voltage.

13. The dual-phase buck-converter of claim 12, wherein the reference current value corresponds to an average value of the master average current and the slave average current.

14. The dual-phase buck-converter of claim 9, further comprising:
an on-time controller configured to generate a master duty signal and a slave duty signal based on the master on-time control voltage and the slave on-time control voltage,
wherein the first buck-converter is configured to generate the master inductor current responsive to the master duty signal, and the second buck-converter is configured to generate the slave inductor current responsive to the slave duty signal.

15. A dual-phase buck-converter comprising:
a master buck-converter chip configured to provide a master inductor current to a load through a first inductor;
a slave buck-converter chip configured to provide a slave inductor current to the load through a second inductor;
a first DC resistance detection circuit configured to detect a first DC resistance value of the first inductor and to generate a first reference voltage indicative of the first DC resistance value; and
a second DC resistance detection circuit configured to detect a second DC resistance value of the second inductor and to generate a second reference voltage indicative of the second DC resistance value,
wherein the master buck-converter chip is further configured to
generate a master average current corresponding to an average value of the master inductor current flowing in the first inductor,
generate a master on-time control voltage reflecting the first DC resistance value based on the master average current, the first reference voltage and the second reference voltage,
generate a master duty signal based on the master on-time control voltage, and
control the master average current based on the master duty signal, and
the slave buck-converter chip is further configured to
generate a slave average current corresponding to an average value of the slave inductor current flowing in the second inductor,
generate a slave on-time control voltage reflecting the second DC resistance value based on the slave average current, the first reference voltage and the second reference voltage,
generate a slave duty signal based on the slave on-time control voltage, and
control the slave average current based on the slave duty signal.

16. The dual-phase buck-converter of claim 15, wherein the master buck-converter chip includes a first current balance circuit, the first current balance circuit comprising:
a first trans-conductor configured to generate a first voltage corresponding to a difference between half of the master average current and a reference current value;
a first buffer configured to buffer the first reference voltage; and
a first feedback resistor configured to add the first reference voltage buffered by the first buffer to the first voltage to provide the master on-time control voltage.

17. The dual-phase buck-converter of claim 16, wherein the slave buck-converter chip includes a second current balance circuit, the second current balance circuit comprising:
a second trans-conductor configured to generate a second voltage corresponding to a difference between half of the slave average current and the reference current value;
a second buffer configured to buffer the second reference voltage; and
a second feedback resistor configured to add the second reference voltage buffered by the second buffer to the second voltage to provide the slave on-time control voltage.

18. The dual-phase buck-converter of claim 17, wherein the reference current value corresponds to an average current value of the master average current and the slave average current.

19. The dual-phase buck-converter of claim 18, wherein the master buck-converter chip includes a first on-time controller, the first on-time controller comprising:
a first ramp generator configured to generate a first ramp signal having a first slope; and
a first comparator configured to generate the master duty signal by comparing the first ramp signal and the master on-time control voltage.

20. The dual-phase buck-converter of claim 19, wherein the slave buck-converter chip includes a second on-time controller, the second on-time controller comprising:
a second ramp generator configured to generate a second ramp signal having the first slope; and
a second comparator configured to generate the slave duty signal by comparing the second ramp signal and the slave on-time control voltage.
